(19) United States
(12) Patent Application Publication
(10) Pub. No.: US 2018/0275607 A1
(43) Pub. Date: Sep. 27, 2018

(54) ILLUMINATION APPARATUS, DISPLAY, AND LIGHT GUIDE DEVICE

(71) Applicant: FUJI XEROX CO., LTD., Tokyo (JP)

(72) Inventors: Shigetoshi NAKAMURA, Kanagawa (JP); Jiro MINABE, Kanagawa (JP); Yasuhiro OGASAWARA, Kanagawa (JP); Takashi FUJIMOTO, Kanagawa (JP)

(73) Assignee: FUJI XEROX CO., LTD., Tokyo (JP)

(21) Appl. No.: 15/642,042

(22) Filed: Jul. 5, 2017

(30) Foreign Application Priority Data
Mar. 23, 2017 (JP) 2017-058242

(51) Int. Cl. G03H 1/22; F21V 8/00

(52) U.S. Cl. CPC G03H 1/2286; G03H 1/2202; G02B 6/0036; G03H 2210/30; G03H 2270/20; G03H 2001/2223; G03H 2223/16

(57) ABSTRACT

An illumination apparatus includes a light source, a light guide plate, and an adjacent layer. The light guide plate includes a first surface, a second surface facing the first surface, and plural light exit portions provided on one of the first and second surfaces. The light guide plate guides therethrough a beam of light incident upon one of the first and second surfaces while reflecting the beam between the first and second surfaces. The light guide plate redirects the beam incident upon any one of the plural light exit portions so as to cause the beam to exit the light guide plate. The adjacent layer provided adjacent to at least one of the first and second surfaces has a lower refractive index than that of the light guide plate and increases a critical angle compared to that observed when air exists instead of the adjacent layer.

### CROSS-REFERENCE TO RELATED APPLICATIONS

This application is based on and claims priority under 35 USC 119 from Japanese Patent Application No. 2017-058242 filed Mar. 23, 2017.

### BACKGROUND

### Technical Field

The present invention relates to an illumination apparatus, a display, and a light guide device.

### SUMMARY

According to an aspect of the present invention, an illumination apparatus includes a light source, a light guide plate, and an adjacent layer. The light guide plate includes a first surface, a second surface which faces the first surface, and plural light exit portions provided on one surface out of the first surface and the second surface. The light guide plate guides through the light guide plate a beam of light incident upon one of the first surface and the second surface while reflecting the beam between the first surface and the second surface. The light guide plate redirects the beam incident upon any one of the plural light exit portions so as to cause the beam to exit the light guide plate. The adjacent layer is provided adjacent to at least one surface out of the first surface of the light guide plate and the second surface of the light guide plate. The adjacent layer has a lower refractive index than a refractive index of the light guide plate. The adjacent layer increases a critical angle compared to a critical angle observed when air exists instead of the adjacent layer.

### BRIEF DESCRIPTION OF THE DRAWINGS

Exemplary embodiments of the present invention will be described in detail based on the following figures, wherein:

FIG. 1 is a sectional view of an example of a configuration of a display according to a first exemplary embodiment of the present invention;

FIG. 2 is a sectional view of an example of operation of the display according toe first exemplary embodiment of the present invention;

FIG. 3 is a schematic view illustrating a core-clad structure;

FIGS. 4A to 4C are schematic views illustrating operation of a cladding layer;

FIG. 5 is a schematic view illustrating a wavenumber vector of a beam of light propagating through a light guide plate;

FIG. 6 is a sectional view of an example of a configuration of the display according to a first variation of the first exemplary embodiment;

FIG. 7 is a sectional view of an example of a configuration of the display according to d variation of the first exemplary embodiment;

FIG. 8 is a sectional view of an example of a configuration of the display according to a second exemplary embodiment of the present invention;

FIG. 9 is a sectional view of an example of operation of the display according to the second exemplary embodiment of the present invention;

FIG. 10 is a sectional view of an example of a configuration of the display according to a third exemplary embodiment of the present invention;

FIG. 11 is a sectional view of an example of operation of the display according to the third exemplary embodiment of the present invention;

FIG. 12 is a sectional view of an example of a configuration of the display according to a fourth exemplary embodiment of the present invention;

FIG. 13 is a sectional view of an example of operation of the display according to the fourth exemplary embodiment of the present invention;

FIG. 14 is a perspective view of an example of a configuration of an illumination apparatus according to an application; and

FIG. 15 is a perspective view of an example of a configuration of a portable display according to an application.

### DETAILED DESCRIPTION

Examples of exemplary embodiments of the present invention will be described in detail below with reference to the drawings.

### First Exemplary Embodiment

### Configuration of a Display

First, a configuration of a display is described.

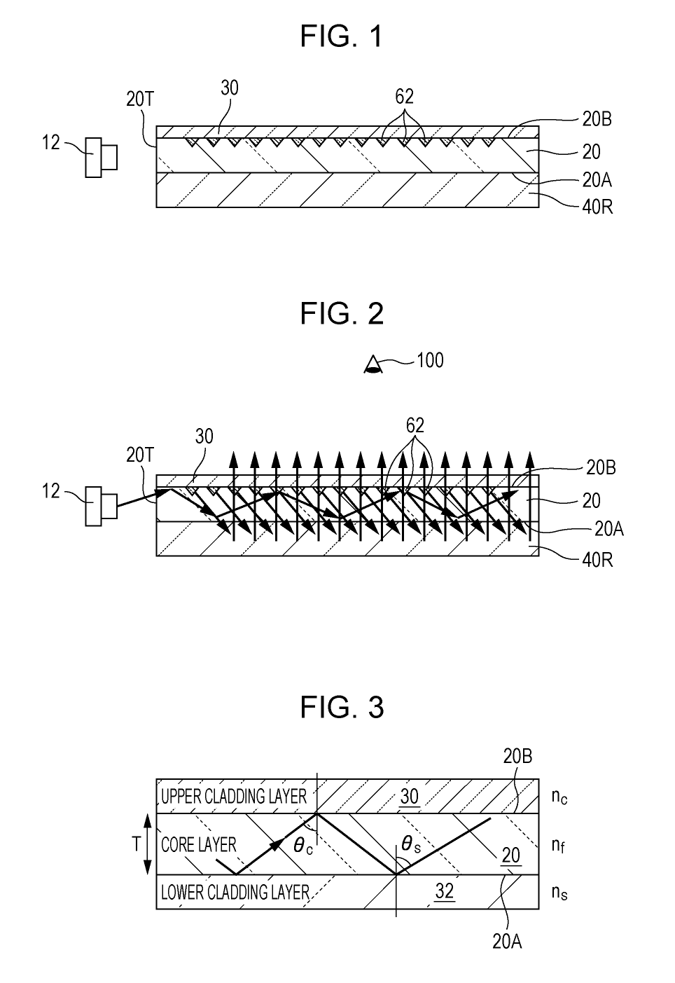

FIG. 1 is a sectional view of an example of the configuration of a display according to a first exemplary embodiment of the present invention. As illustrated in FIG. 1, the display according to the present exemplary embodiment illuminates a hologram recording medium 40R with a beam of light exiting alight guide plate 20 so as to display a “stereoscopic image” recorded in the hologram recording medium 40R.

The display includes a light source 12, the light guide plate 20 provided with a cladding layer 30, and the hologram recording medium 40R. The light source 12 is disposed so as to face an end surface 20T of the light guide plate 20. The hologram recording medium 40R is disposed adjacent to the light guide plate 20. More specifically, the hologram recording medium 40R is in tight contact with the light exit side of the light guide plate 20.

According to the present exemplary embodiment, the light guide plate 20 provided with the cladding layer 30 is an example of a “light guide device”. A combination of the light source 12 and the light guide plate 20 is an example of an “illumination apparatus”. The cladding layer 30 provided for the light guide plate 20 as a core layer is an example of an “adjacent layer”.

The light guide plate 20 is a polyhedron such as a flat plate formed of transparent resin or glass. In the illustrated example, the light guide plate 20 has a rectangular parallelepiped shape. The term “transparent” here means that the guided beam is transmitted or reflected. The light guide plate 20 guides in an in-plane direction the bean incident upon the end surface 20T and causes the guided beam to exit through a light exit surface. Here, the term “in-plane direction” refers to a direction within a plane in which the beam is guided by the light guide plate 20 along the light exit surface.

The hologram recording medium 40R is a sheet-shaped recording medium formed of transparent resin or glass. The term “transparent” here means that the beam for illumination is transmitted or reflected. A reflection hologram of a stereoscopic image is recorded in the hologram recording medium 40R. Here, the term “reflection hologram” refers to a type of hologram recorded by respectively radiating an object beam and a reference beam from one surface side and the opposite surface side toward a recording medium. When an illumination beam is radiated toward a reflection hologram, a stereoscopic image is displayed on a radiated surface side radiated with the illumination beam.

The stereoscopic image (three-dimensional object image) is recorded as a reflection hologram by using the object beam having image information of the stereoscopic image. Examples of image information of the stereoscopic image include image information of a parallax image which is a stereoscopic image displayed with parallax continued in a viewpoint moving direction.

As the hologram recording medium 40R, a recording medium having a large film thickness is suited. Plural interference fringes for diffraction in the film thickness direction are recorded in a recording medium having a large film thickness. A hologram recorded in the recording medium having a large film thickness has high angular selectivity and reproduced only with a beam of light incident thereupon at a limited angle. Accordingly, quality of the reproduced stereoscopic image is not degraded even when a divergent angle of the illumination beam is large.

The visibility of the stereoscopic image is improved when the illumination beam radiated toward the reflection hologram is a “parallel beam” having the same angle as that of the reference beam used to record the reflection hologram. The illumination beam incident at a different angle from that of the reference beam is transmitted or reflected instead of diffracted by the reflection hologram and becomes an unnecessary beam other than a reproduction beam. The unnecessary beam decreases the visibility of the stereoscopic image. In order to prevent scattering or reflecting of the unnecessary beam that has been transmitted through the reflection hologram instead of having been diffracted by the reflection hologram, an optical absorber may be disposed on a back surface (on the opposite side to an observer 100) of the hologram recording medium 40R. The optical absorber also absorbs external beams.

### The Light Source

A light emitting diode (LED), a xenon lamp, a semiconductor laser, an organic electroluminescent (EL) element, a cold-cathode tube, a fluorescent lamp, or the like is used as the light source 12. The beam emitted from the light source 12 includes a light component having the same wavelength as that of the object beam and the reference beam used for recording the “reflection hologram”.

### The Light Guide Plate and the Cladding Layer

The light guide plate 20 includes a first surface 20A and a second surface 20B facing the first surface 20A. The light guide plate 20 is formed of transparent resin or glass having a refractive index higher than that of the air. The term “transparent” here means that the guided beam is transmitted or reflected. The cladding layer 30 is provided adjacent to the second surface 20B of the light guide plate 20. An interface between the light guide plate 20 and the cladding layer 30 is the second surface 20B.

The cladding layer 30 is formed of transparent resin or glass having a refractive index that is lower than that of the light guide plate 20 and higher than that of the air. The term “transparent” here means that the incident beam is transmitted or reflected. The light guide plate 20 guides the beam incident thereupon in the in-plane direction while reflecting the beam between the first surface 20A and the cladding layer 30.

Furthermore, the light guide plate 20 includes plural light exit portions 62. In order to configure the light guide plate 20 as a surface illumination apparatus, the plural light exit portions 62 are disposed throughout a region of the second surface 20B facing a light exit region of the first surface 20A. Each of the plural light exit portions 62 is a reflective optical element structure such as a microprism that redirects the beam incident thereupon. Degradation of the visibility of the stereoscopic image is decreased when each of the plural light exit portions 62 has a microstructure.

Each of the plural light exit portions 62 reflects the beam incident thereupon in a predetermined direction so as to cause the beam to exit through the first surface 20A. According to the first exemplary embodiment, the first surface 20A is the light exit surface. Here, the “predetermined direction” refers to such a direction that, when the beam reflected by the reflective optical element is incident upon the first surface 20A in the “predetermined direction”, the beam exits without being reflected. The reflective optical elements also include recesses or projections provided in the light exit surface. The recesses or the projections may have a shape such as a conical shape, a pyramid shape, a cylindrical shape, a prismatic shape, or a hemispherical shape.

Portions of the second surface 20B where no light exit portion 62 is provided reflect the beam incident thereupon toward the first surface 20A side. That is, the beam reflected by the second surface 20B is guided through the light guide plate 20 by being reflected by the first surface 20A.

The beam travels through the light guide plate 20 while repeatedly being subjected to total reflection in accordance with waveguide mode conditions. Rays of the beam incident upon the plural light exit portions 62 are redirected and out of the waveguide mode conditions. These rays are extracted to the outside under the leaky mode conditions. As will be described later, orientations of the rays of the exit beam are aligned more as the waveguide modes decrease.

The plural light exit portions 62 may be arranged in rows and columns or randomly arranged in the second surface 20B. In order to obtain a uniform surface illumination apparatus in which the amounts of exit light are equalized in the light exit region, the plural light exit portions 62 have the same or similar shape. Furthermore, the beam guided through the light guide plate 20 is attenuated as the distance by which the beam is guided increases. Accordingly, in order to obtain the uniform surface illumination apparatus, the number of light exit portions 62 per unit area may be increased toward a portion of the light guide plate 20 farthest from the light source 12.

### Operation of the Display

Next, operation of the display is described.

FIG. 2 is a sectional view of an example of the operation of the display according to the first exemplary embodiment of the present invention. As illustrated in FIG. 2, the beam emitted from the light source 12 is incident upon the light guide plate 20 at the end surface 20T. The beam incident upon the light guide plate 20 is guided in the in-plane direction while being reflected between the first surface 20A and the cladding layer 30. The beam guided through the light guide plate 20 is reflected by the plural light exit portions 62 and exits through the first surface 20A. The beam exiting through the first surface 20A is a parallel beam the rays of which are oriented at aligned orientation angles.

Here, the term “orientation angles” refers to angles formed between the optical axes of the rays of the exit beam and the normal to the second surface 20B. According to the present exemplary embodiment, the first surface 20A and the second surface 20B are parallel to each other. Accordingly, the normal to the second surface 20B is the normal to the first surface 20A. As will be described later, due to existence of the cladding layer 30, a critical angle θ increases. This decreases a range of the incident angle of the beam incident upon the first surface 20A and the second surface 20B, thereby the orientation angles of the rays of the exit beam are aligned.

The parallel beam having exited the light guide plate 20 through the first surface 20A is radiated toward the hologram recording medium 40R as the “illumination beam”. The illumination beam is front light that illuminates the hologram recording medium 40R from the front side (the same side as the observer 100).

When the illumination beam is radiated toward the hologram recording medium 40R, the illumination beam is diffracted by the reflection hologram, thereby a “reproduction beam” exits through the surface toward which the illumination beam is radiated. That is, the reproduction beam exits toward the observer 100 side. This causes the stereoscopic image recorded in the hologram recording medium 40R to be displayed for the observer 100. According to the present exemplary embodiment, the illumination beam (parallel beam) may be generated without use of a complex optical system. Accordingly, a compact display may be provided.

### Operation of the Cladding Layer

Next, operation of the cladding layer is described,

FIG. 3 is a schematic view illustrating a core-clad structure. As illustrated in FIG. 3, physical properties of each of layers of a slab type waveguide having a core-clad structure are defined. A film thickness of the core layer is defined as T, the refractive index of the core layer is defined as n_{f}, the refractive index of an upper cladding layer is defined as n_{c}, and the refractive index of a lower cladding layer is defined as nₛ. A critical angle θ_{c} at an interface between the core layer and the upper cladding layer is given by the following expression (1). A critical angle θₛ at an interface between the core layer and the lower cladding layer is given by the following expression (2). Here, the “critical angle” refers to a minimum incident angle at which total reflection occurs. The incident angle refers to an angle formed between the axis of incident beam and the normal to a surface upon which the beam is incident.

θ_{c}=sin⁻¹ (n_{c}/n_{f}) (1).

θₛ=sin⁻¹ (nₛ/n_{f}) (2).

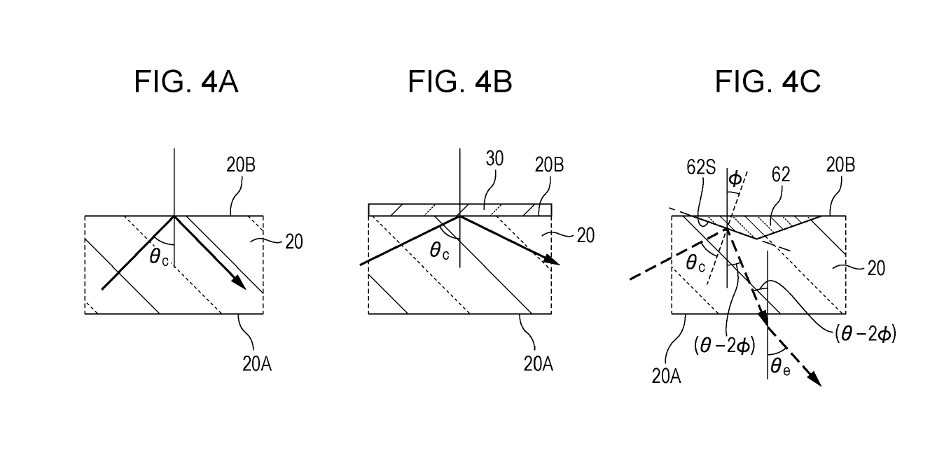

FIGS. 4A to 4C are schematic views illustrating the operation of the cladding layer. In the case where the cladding layer 30 is provided on the second surface 20B of the light guide plate 20, the orientation angles of the rays of the exit beam are aligned compared to the case where the cladding layer 30 is not provided. The principles of aligning the orientation angles of the rays of the exit beam are described.

As illustrated in FIG. 4A, in the case where the cladding layer 30 is not provided, that is, in the case where an air layer (refractive index n_{c}=1) is provided on each side of the light guide plate 20, the critical angle θ_{c} is determined in accordance with the refractive index n_{f} of the light guide plat 20 (core layer).

For example, it is assumed that the light guide plate 20 is formed of “polymethyl methacrylate (PMMA)”. The refractive index of the PMMA with visible light is from 1.49 to 1.50. In the case where the cladding layer 30 is not provided, the critical angle θ_{c} is 42°. The beam incident upon the light guide plate 20 is guided while being reflected at interfaces. The interfaces here are interfaces between the light guide plate 20 and the air layers (first surface 20A/second surface 20B). The incident angle θ at the interfaces is in the following range: 42°<θ<90°.

In contrast, as illustrated in FIG. 4B, in the case where the cladding layer 30 is provided on the second surface 20B of the light guide plate 20, the critical angle θ_{c} is determined in accordance with the refractive index n_{f} of the light guide plate 20 and the refractive index n_{c} of the cladding layer 30.

For example, it is assumed that the light guide plate 20 is formed of PMMA, and the difference in refractive index between the light guide plate 20 and the cladding layer 30 is 0.01. In the case where the cladding layer 30 is provided, the critical angle θ_{c} is increased to 83°. The beam incident upon the light guide plate 20 is guided while being reflected at interfaces. The interfaces here are an interface between the light guide plate 20 and the air layer (first surface 20A) and an interface between the light guide plate 20 and the cladding layer 30 (second surface 20B). The incident angle θ to the interfaces is in the following range: 83°<θ<90°.

In the case where the cladding layer 30 is provided, the range of the incident angle θ of the beam incident upon the interfaces is decreased compared to the case where the cladding layer 30 is not provided. In the exemplified settings, the range of the incident angle θ in the case where the cladding layer 30 is provided is limited to a range which is about a one-seventh of the range of the incident angle θ in the case where the cladding layer 30 is not provided.

In an example illustrated in FIG. 4C, each of the light exit portions 62 is a microprism. The microprism includes an inclined surface 62s inclined by an angle ϕ relative to the second surface 20B of the light guide plate 20. An angle formed between the normal to the second surface 20B and the normal to the inclined surface 62s is ϕ. When the total reflection conditions are satisfied, the beam propagating at the angle θ is reflected by the inclined surface 62s at an angle (θ−2ϕ) relative to the normal to the second surface 20B.

In the case where the beam reflected at the angle (θ−2ϕ) does not satisfy the total reflection conditions when the beam is incident upon the first surface 20A of the light guide plate 20, the beam exits through the first surface 20A instead of being reflected by the first surface 20A. The exit angle θₑ at this time is given by the following expression (3).

sin θₑ=n_{f} sin (θ−2ϕ) (3).

Here, it is assumed that the light guide plate 20 is formed of PMMA. In the case where the cladding layer 30 is not provided, the range of the critical angle θ_{c} is 42.2°<θ<90°. When the inclination angle ϕ of the inclined surface 62s is 25°, the exit angle θₑ is in the following range: −11.7°<θₑ<73.3°. Thus, the orientation angle varies among the rays of the exit beam.

In contrast, in the case where the cladding layer 30 the refractive index of which is different by 0.01 from that of the light guide plate 20 is provided, the range of the critical angle θ_{c} is 83.4°<θ<90°. When the inclination angle (θ−2ϕ) of the inclined surface 62s is 25°, the exit angle θₑ is in the following range: 55.1°<θₑ<73.3°. Thus, the range of the exit angle θ is decreased, and accordingly, the orientation angles of the rays of the exit beam are aligned. In other words, a distribution of the orientation angle of the exit beam is decreased.

### An Increase in the Equivalent Refractive Index

The decrease in the range of the incident angle of the beam incident upon the interface, which has been explained from the viewpoint of the increase in the critical angle in the above description, will be explained from the viewpoint of an increase in an “equivalent refractive index N” given by the following expression (4).

N=n_{f} sin θ (4).

Propagating beam guided through the light guide plate 20 is able to be considered as a plane wave a propagation constant for which is β defined by expression (6) to be described later. Accordingly, the equivalent refractive index N is, when the plane wave travels in a waveguide medium, equivalent to the refractive index of the medium. When a larger of the refractive index n_{c} of the upper cladding layer and the refractive index nₛ of the lower cladding layer is “n”, the equivalent refractive index N takes discrete values in the following range: n<N<n_{f}.

For example, it is assumed that the light guide plate 20 is formed of PMMA. In the case where the cladding layer 30 is not provided, the equivalent refractive index N is able to be a value in the following range: 1<N<1.49. When the range of the incident angle θ of the beam incident upon the interface is calculated by using the above-described expression (4), the incident angle θ is in the following range: 42.20<θ<90°.

In contrast, in the case where the cladding layer 30 the refract index of which is different by 0.01 from that of the light guide plate 20 is provided, the equivalent refractive index N is able to be a value in the following range: 1.48<N<1.49. Thus, the equivalent refractive index N is increased compared to the case where the cladding layer 30 is not provided. When the range of the incident angle θ of the beam incident upon the interface is calculated by using the above-described expression (4), the incident angle θ is in the following range: 83.4°<θ<90°. As the equivalent refractive index N increases, the range of the incident angle of the beam incident upon the interface decreases.

### The Decrease in the Waveguide Modes

Furthermore, with the cladding layer 30, the waveguide modes of the beam guided through the light guide plate 20 decrease. The reason why the orientation angle of the exit beam is limited is explained from the viewpoint of the decrease in the waveguide modes.

The “waveguide modes” in which the beam is incident upon the interface at the incident angle θ in a specified range and guided while being reflected by the interface exist in the light guide plate 20. Furthermore, the beam incident upon the interface at an incident angle out of the specified range is not in the waveguide modes. Thus, such a beam does not satisfy the conditions of a standing wave and is canceled out. In this way, the waveguide modes are maintained. Accordingly, when the waveguide modes decrease, the orientation angle of the exit beam is limited.

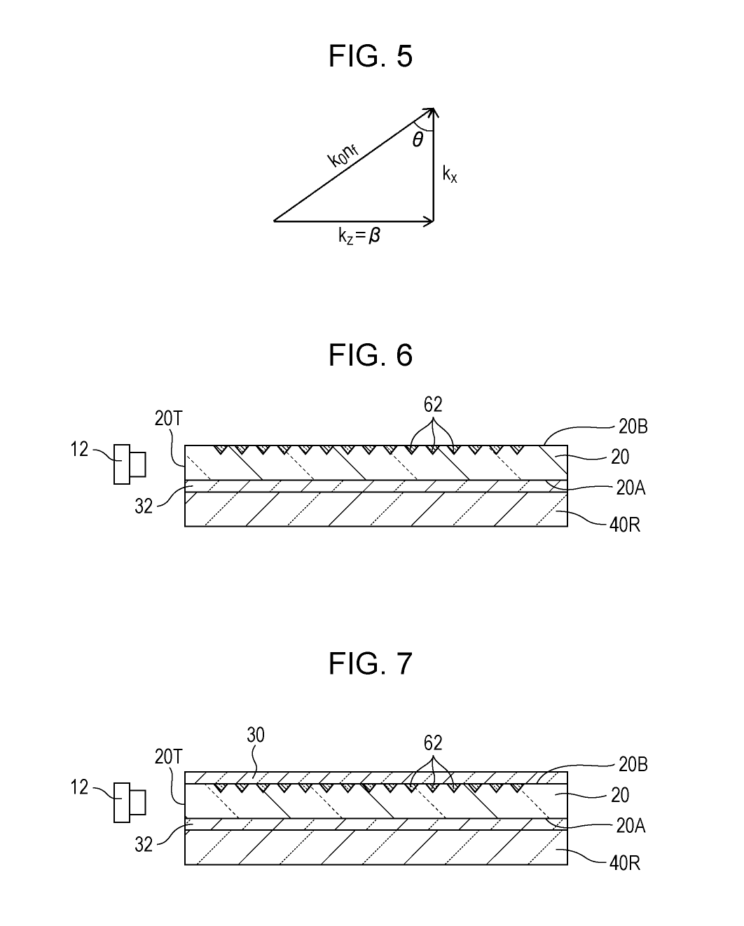

The propagating beam guided through the light guide plate 20 is described below. FIG. 5 is a schematic view illustrating a wavenumber vector of the beam propagating through the light guide plate. As illustrated in FIG. 5, the propagating beam is able to be represented as a wavenumber vector. The wavenumber in the propagating direction is k₀n_{f} and, when λ is a light wavelength in a free space, k₀=2π/λ. Accordingly, components of the propagation constant in the X direction and the Z direction are respectively represented by the following expressions (5) and (6).

kₓ=k₀n_{f} cos θ (5).

k_{z}=k₀n_{f} sin θ=β (6).

It is known that a beam propagating through a waveguide takes an eigen discrete waveguide mode. An eigenvalue equation of the waveguide mode is, in a transverse electric mode (TE mode), given by the following expression (7). Here, m=0, 1, 2, . . .

$${k}_{x} T = ( m + 1 ) π - {tan}^{- 1} ( \frac{{k}_{x}}{{γ}_{s}} ) - {tan}^{- 1} ( \frac{{k}_{x}}{{γ}_{c}} ) . \qquad ( 7 )$$

An eigenvalue equation in a transverse magnetic mode (TM mode) is given by the following expression (8).

$${k}_{x} T = ( m + 1 ) π - {{tan}^{- 1} ( \frac{{n}_{s}}{{n}_{f}} )}^{2} ( \frac{{k}_{x}}{{γ}_{s}} ) - {{tan}^{- 1} ( \frac{{n}_{c}}{{n}_{f}} )}^{2} ( \frac{{k}_{x}}{{γ}_{c}} ) . \qquad ( 8 )$$

Here, kₓ, γ_{c}, and γₛ are defined by the following expressions (9) to (11).

kₓ=k₀\sqrt{n_{f}²−N²} (9),

γ_{c}=k₀\sqrt{N²−n_{c}²} (10), and

γₛ=k₀\sqrt{N²−nₛ²} (11).

For example, it is assumed that the light guide plate 20 is formed of PMMA having a thickness of 10 μm. When propagating a beam having a wavelength of 532 nm in the light guide plate 20, it is deduced that 40 TE modes are able to exist by using the above-described expression (7) in the case where the cladding layer 30 is not provided. Furthermore, a propagation angle at this time is in the following range; 42.81°<θ<87.98°.

In contrast, in the case where the cladding layer 30 the refractive index of which is different by 0.01 from that of the light guide plate 20 is provided, 5 TE modes are able to exist. The propagation angle at this time is in the following range: 83.65°<θ<88.14°. When the number of waveguide modes decreases, the angle of the propagating beam decreases. Accordingly, the angle of divergence of the reproduction beam decreases when illuminating a hologram.

### The Structures and a Fabrication Method of the Core Layer and the Cladding Layer

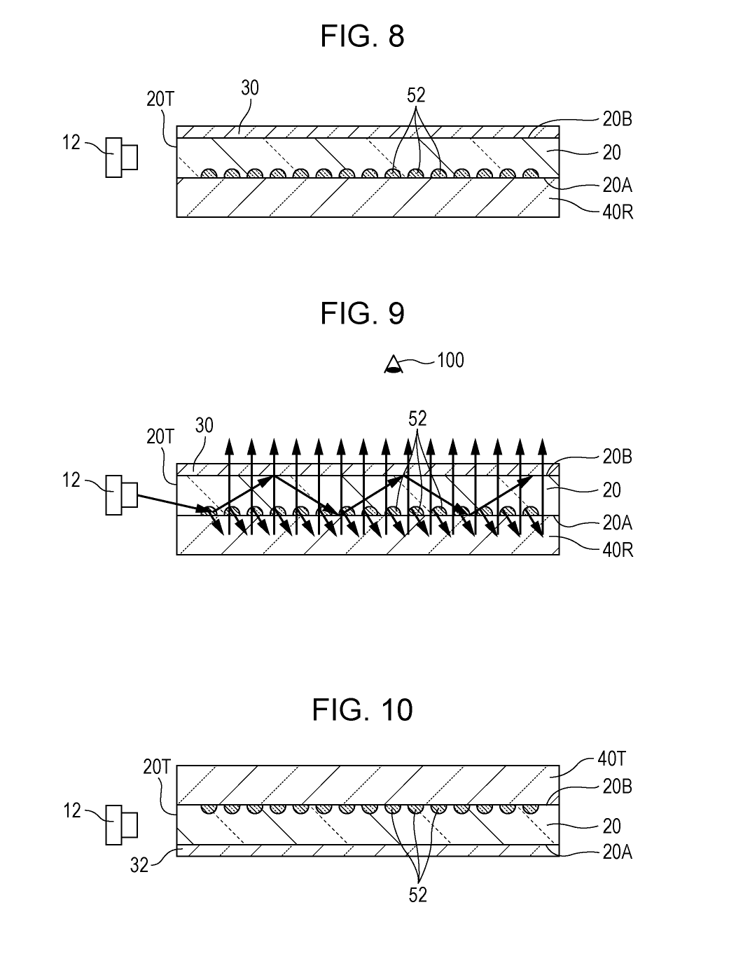

Next, examples of the structures and a fabrication method of the light guide plate (core layer), the light exit portions, and the cladding layer are described. For example, FIGS. 1 and 8 are referred to for the structures of the light guide plate 20, light exit portions 52, the light exit portions 62, the cladding layer 30 and the cladding layer 32.

The light guide plate 20 is fabricated by, for example, deposition or molding with transparent resin as a base material. Examples of the transparent resin include a thermoplastic resin and thermocurable resin having high transparency such as, for example, polycarbonate, acrylic resin, polyolefin, urethane resin, and polyethylene terephthalate. Among these, polycarbonate, acrylic resin, or urethane resin, which does not have a wavelength absorption range in the visible light range and which has high transparency, is suited. A variety of additives are added to the transparent resin.

The light exit portions 52 and 62 and the cladding layers 30 and 32 are each formed on a surface of the light guide plate 20 by, for example, ink-jet printing with, for example, a resin that is transparent and usable for printing as a material. The resin that is transparent and usable for printing is a mixture of a transparent resin, an ultraviolet (UV) curing agent, an additive, and so forth. Examples of the transparent resin include the resin used to form the light guide plate 20. Examples of the additive include, for example, titanium oxide. The resin that is transparent and usable for printing dropped on the surface of the light guide plate 20 and irradiated with UV after being dropped, thereby causing the resin to be firmly fixed to the surfaces of the light guide plate 20.

The light guide plate 20 having a thickness of from 0.01 to 1 mm is suited. As the thickness of the light guide plate 20 decreases, the critical angle increases, and accordingly, the waveguide modes decrease. Thus, when the thickness of the light guide plate 20 is small, the orientation angles of the rays of the exit beam are aligned. However, when the thickness of the light guide plate 20 is smaller than 0.01 mm, a special image forming structure is required to couple the beam from the light source 12 to the light guide plate 20. When the thickness is large than 1 mm, the multiplicity of the waveguide modes increases. This makes it difficult to control the orientation angle of the exit beam. Furthermore, the weight and volume of the light guide plate 20 increase. This leads to degradation of handling properties.

The refractive index of the light guide plate 20 is not particularly limited as long as the visible light used to reproduce the hologram is able to propagate. However, as a range of the refractive index of a general resin material or a glass material, a refractive index of the light guide plate 20 of about 1.3 to 1.8 is suited. The end surface 20T of the light guide plate 20 may be a flat surface substantially perpendicular to the first surface 20A and the second surface 20B. The end surface 20T of the light guide plate 20 may be a flat surface that intersects the first surface 20A and the second surface 20B.

The cladding layers 30 and 32 are formed of a material the refractive index of which is different from that of the light guide plate 20 by a range from 0.001 to 0.1. When the refractive index is larger than 0.1, a light confinement effect increases. This leads to an increase in the critical angle, a decrease in the equivalent refractive index, and an increase in the number of waveguide modes. When the refractive index is smaller than 0.001, it is difficult to excite the waveguide modes.

The light exit portions 52 or 52 of the light guide plate 20 are able to be integrally formed with the light guide plate 20 by injection molding using a mold when the light guide plate 20 is formed. Alternatively, the light exit portions 52 or 62 of the light guide plate 20 are able to be integrally formed with the light guide plate 20 by, for example, machining a surface of a resin material having a sheet shape or nanoimprinting, while heating the sheet-shaped resin material, performed on the surface of the sheet-shaped resin material. Alternatively, the light exit portions 52 or 62 may be formed by bonding another material having a surface on which a light exit portion structure is formed. It is sufficient that the thickness (height) of the light exit portions 52 and 62 be in such a range that the visibility of a reproduced image is not degraded. The light exit portions 52 and 62 having a thickness of, for example, from 1 μm to 300 μm is suited. When the thickness is about 300 μm or larger, the visibility is degraded due to the structure of the light exit portions.

### First Variation

Next, a first variation of the first exemplary embodiment is described.

FIG. 6 is a sectional view of an example of a configuration of the display according to the first variation of the first exemplary embodiment. In the example illustrated in FIG. 1, the cladding layer 30 is provided on the second surface 20B of the light guide plate 20. However, as illustrated in FIG. 6, the cladding layer 32 may be provided on the first surface 20A of the light guide plate 20. The light guide plate 20 guides a beam of light incident thereupon in the in-plane direction while reflecting the beam between the second surface 20B and the cladding layer 32. With the cladding layer 32, the beam exiting through the first surface 20A is a parallel beam rays of which are oriented at aligned orientation angles compared to the case where the cladding layer is not provided.

### Second Variation

Next, a second variation of the first exemplary embodiment is described.

FIG. 7 is a sectional view of an example of a configuration of the display according to the second variation of the first exemplary embodiment. In the example illustrated in FIG. 1, the cladding layer 30 is provided on the second surface 20B of the light guide plate 20. However, as illustrated in FIG. 7, in addition to the cladding layer 30 provided on the second surface 20B of the light guide plate 20, the cladding layer 32 may be provided on the first surface 20A of the light guide plate 20. The light guide plate 20 guides a beam of light incident thereupon in the in-plane direction while reflecting the beam between the cladding layer 30 and the cladding layer 32. With the cladding layer 30 and the cladding layer 32, the beam exiting through the first surface 20A is a parallel beam rays of which are oriented at aligned orientation angles compared to the case where the cladding layers are not provided.

### Second Exemplary Embodiment

Next, a second exemplary embodiment is described.

FIG. 8 is a sectional view of an example of a configuration of the display according to the second exemplary embodiment of tie present invention. As illustrated in FIG. 8, according to the second exemplary embodiment, the plural light exit portions 52 are provided on the first surface 20A of the light guide plate instead of the plural light exit portions 62 provided on the second surface 20B of the light guide plate 20. Other than this difference, the configuration of the second exemplary embodiment is the same as or similar to the first exemplary embodiment. Thus, like elements are denoted by like reference numerals and description thereof is omitted.

### Configuration of the Display

First, a configuration of the display is described.

The display includes the light source 12, the light guide plate 20 provided with the cladding layer 30, and the hologram recording medium 40R. The light source 12 is disposed so as to face the end surface 20T of the light guide plate 20. The hologram recording medium 40R is in tight contact with the light guide plate 20 on the light exit side of the light guide plate 20. A reflection hologram of a stereoscopic image is recorded in the hologram recording medium 40R.

The light guide plate 20 includes the first surface 20A, the second surface 20B facing the first surface 20A, and the cladding layer 30. The cladding layer 30 is provided on the second surface 20B of the light guide plate 20. The light guide plate 20 guides a beam of light incident thereupon in the in-plane direction while reflecting the beam between the first surface 20A and the cladding layer 30. According to the second exemplary embodiment, the first surface 20A is the light exit surface.

Furthermore, in order to configure the light guide plate 20 as a surface illumination apparatus, the plural light exit portions 52 are provided on the first surface 20A of the light guide plate 20. The plural light exit portions 52 are disposed throughout the light exit region of the first surface 20A of the light guide plate 20. The plural light exit portions 52 may be, as is the case with the plural light exit portions 62 according to the first exemplary embodiment, arranged in rows and columns or randomly arranged.

Each of the plural light exit portions 52 forms an optical element structure such as a microlens or a prism that redirects the beam incident thereupon. Angles at which rays of the beam are incident upon the plural light exit portions 52 are different from angles at which rays of the beam are incident upon portions of the light guide plate 20 around the light exit portions 52. Thus, the rays of the beam incident upon the light exit portions 52 are refracted and exit through the first surface 20A by changing propagation angles. The optical element structures also include recesses or projections provided in the light exit surface. The recesses or the projections may have a shape such as a conical shape, a pyramid shape, a cylindrical shape, a prismatic shape, or a hemispherical shape. Portions of the first surface 20A where the light exit portions 52 are not provided reflect the beam incident thereupon toward the second surface 20B side.

### Operation of the Display

Next, operation of the display is described.

FIG. 9 is a sectional view of an example of the operation of the display according to the second exemplary embodiment of the present invention. As illustrated in FIG. 9, the beam emitted from the light source 12 is incident upon the light guide plate 20 at the end surface 20T. The beam incident upon the light guide plate 20 is guided in the in-plane direction while being reflected between the first surface 20A and the cladding layer 30. The beam guided through the light guide plate 20 is refracted by the plural light exit portions 52 and exits through the first, surface 20A. The beam exiting through the first surface 20A is a parallel beam rays of which are oriented at aligned orientation angles.

The parallel beam having exited the light guide plate 20 through the first surface 20A is radiated toward the hologram recording medium 40R as the “illumination beam”. The illumination beam is front light. When the illumination beam is radiated toward the hologram recording medium 40R, the illumination beam is diffracted by the reflection hologram, thereby a “reproduction beam” exits toward the observer 100 side. This causes the stereoscopic image recorded in the hologram recording medium 40R to be displayed for the observer 100.

### Third Exemplary Embodiment

Next, a third exemplary embodiment is described.

FIG. 10 is a sectional view of an example of a configuration of the display according to the third exemplary embodiment of the present invention. As illustrated in FIG. 10, the display according to the third exemplary embodiment illuminates a hologram recording medium 40T with a beam exiting the light guide plate 20 so as to display a “stereoscopic image” recorded in the hologram recording medium 40T. A transmission hologram of the stereoscopic image is recorded in the hologram recording medium 40T.

The hologram recording medium 40T is a sheet-shaped recording medium formed of transparent resin or glass. The term “transparent” here means that the beam for illumination is transmitted or reflected. A transmission hologram of the stereoscopic image is recorded in the hologram recording medium 40T. Here, the term “transmission hologram” refers to a type of hologram recorded by radiating an object beam and a reference beam from the same side toward a recording medium. When an illumination beam is radiated toward a transmission hologram, a stereoscopic image is displayed on the opposite surface side to the radiated surface side radiated with the illumination beam.

### Configuration of the Display

First, a configuration of the display is described.

The display includes the light source 12, the light guide plate 20 provided with the cladding layer 32, and the hologram recording medium 40T. The light source 12 is disposed so as to face the end surface 20T of the light guide plate 20. The hologram recording medium 40T is in tight contact with the light guide plate 20 on the light exit side of the light guide plate 20.

The light guide plate 20 includes the first surface 20A, the second surface 20B facing the first surface 20A, and the cladding layer 32, The cladding layer 32 is provided on the first surface 20A of the light guide plate 20. The light guide plate 20 guides a beam of light incident thereupon in the in-plane direction while reflecting the beam between the second surface 20B and the cladding layer 32. According to the third exemplary embodiment, the second surface 20B is the light exit surface.

Furthermore, the plural light exit portions 52 are provided on the second surface 20B of the light guide plate 20. As is the case with the second exemplary embodiment, each of the plural light exit portions 52 is an optical element structure such as a microlens or a prism that redirects the beam incident thereupon. Each of the plural light exit portions 52 refracts the beam incident thereupon so as to cause the beam to exit through the second surface 20B.

The plural light exit portions 52 are disposed throughout a light exit region of the second surface 20B of the light guide plate 20. The plural light exit portions 52 may be, as is the case with the plural light exit portions 62 according to the first exemplary embodiment, arranged in rows and columns or randomly arranged.

### Operation of the Display

Next, operation of the display is described.

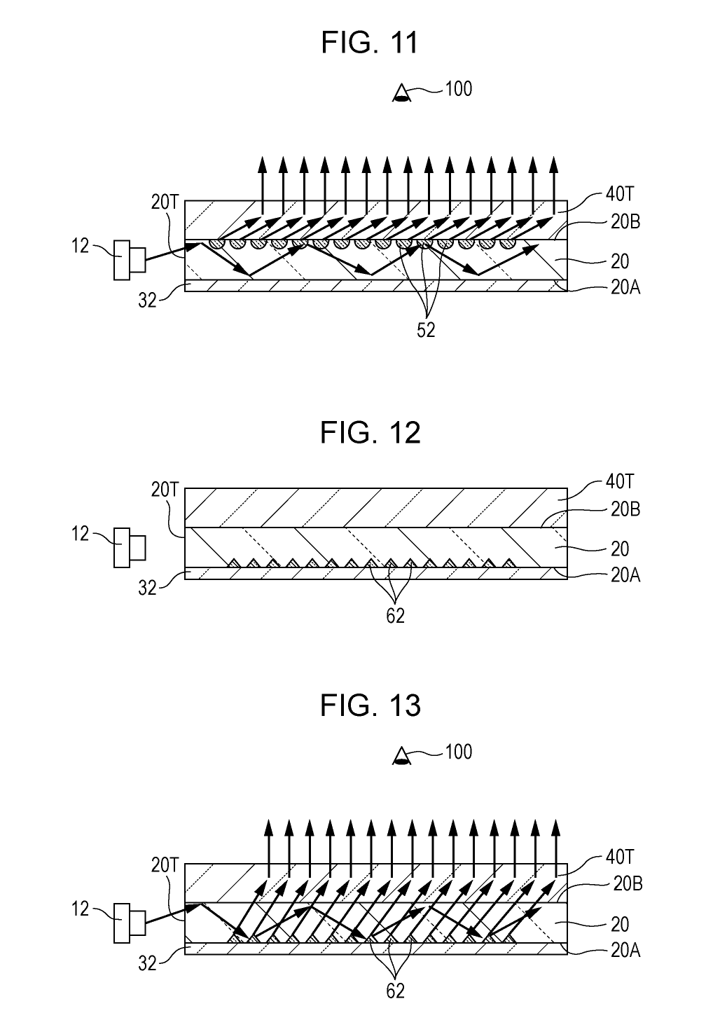

FIG. 11 is a sectional view of an example of the operation of the display according to the third exemplary embodiment of the present invention. As illustrated in FIG. 11, the beam emitted from the light source 12 is incident upon the light guide plate 20 at the end surface 20T. The beam incident upon the light guide plate 20 is guided in the in-plane direction while being reflected between the second surface 20B and the cladding layer 32.

The beam guided through the light guide plate 20 is refracted by the plural light exit portions 52 and exits through the second surface 20B. The beam exiting through the second surface 20B is a parallel beam rays of which are oriented at aligned orientation angles. The parallel beam having exited is radiated toward the hologram recording medium 40T as the “illumination beam”. The illumination beam is back light that illuminates the hologram recording medium 40T from the back side (the opposite side to the observer 100).

When the illumination beam is radiated toward the hologram recording medium 40T, the illumination beam is diffracted by the transmission hologram, thereby a “reproduction beam” exits through a different surface from the surface toward which the illumination beam is radiated. That is, the reproduction beam exits toward the observer 100 side. This causes the stereoscopic image recorded in the hologram recording medium 40T to be displayed for the observer 100.

### Fourth Exemplary Embodiment

Next, a fourth exemplary embodiment is described.

FIG. 12 is a sectional view of an example of a configuration of the display according to the fourth exemplary embodiment of the present invention. As illustrated in FIG. 12, according to the fourth exemplary embodiment, the plural light exit portions 62 are provided on the first surface 20A of the light guide plate 20 instead of the plural light exit portions 52 provided on the second surface 20B of the light guide plate 20. Other than this difference, the configuration of the fourth exemplary embodiment is the same as or similar to the third exemplary embodiment. Thus, like elements are denoted by like reference numerals and description thereof is omitted.

### Configuration of the Display

First, a configuration of the display is described.

The display includes the light source 12, the guide plate 20 provided with the cladding layer 32, and the hologram recording medium 40T. The light source 12 is disposed so as to face the end surface 20T of the light guide plate 20. The hologram recording medium 40T is in tight contact with the light guide plate 20 on the light exit side of the light guide plate 20.

The light guide plate 20 includes the first surface 20A, the second surface 20B facing the first surface 20A, and the cladding layer 32. The cladding layer 32 is provided on the first surface 20A of the light guide plate 20. The light guide plate 20 guides a beam of light incident thereupon in the in-plane direction while reflecting the beam between the second surface 20B and the cladding layer 32. According to the fourth exemplary embodiment, the second surface 20B is the light exit surface.

Furthermore, the plural light exit portions 62 are provided on the first surface 20A of the light guide plate 20. As is the case with the first exemplary embodiment, each of the plural light exit portions 62 is a reflective optical element structure such as a microprism that redirects the beam incident thereupon. Each of the plural light exit portions 62 reflects the beam incident thereupon so as to cause the beam to exit through the second surface 20B.

The plural light exit portions 62 are disposed throughout a region of the first surface 20A of the light guide plate 20 facing the light exit region of the second surface 20B of the light guide plate 20. The plural light exit portions 62 may be, as is the case with the plural light exit portions 62 according to the first exemplary embodiment, arranged in rows and columns or randomly arranged.

### Operation of the Display

Next, operation of the display described.

FIG. 13 is a sectional view of an example of the operation of the display according to the fourth exemplary embodiment of the present invention. As illustrated in FIG. 13, the beam emitted from the light source 12 is incident upon the light guide plate 20 at the end surface 20T. The beam incident upon the light guide plate 20 is guided in the in-plane direction while being reflected between the second surface 20B and the cladding layer 32.

The beam guided through the light guide plate 20 is reflected by the plural light exit portions 62 and exits through the second surface 20B. The beam exiting through the second surface 20B is a parallel beam rays of which are oriented at aligned orientation angles. The parallel beam having exited is radiated toward the hologram recording medium 40T ae the “illumination beam”. The illumination beam is back light that illuminates the hologram recording medium 40T from the back side (the opposite side to the observer 100).

When the illumination beam is radiated toward the hologram recording medium 40T, the illumination beam is diffracted by the transmission hologram, thereby a “reproduction beam” exits through a different surface from the surface toward which the illumination beam is radiated. That is, the reproduction beam exits toward the observer 100 side. This causes the stereoscopic image recorded in the hologram recording medium 40T to be displayed for the observer 100.

### Applications

### Illumination Apparatus

Next, an application to an illumination apparatus is described.

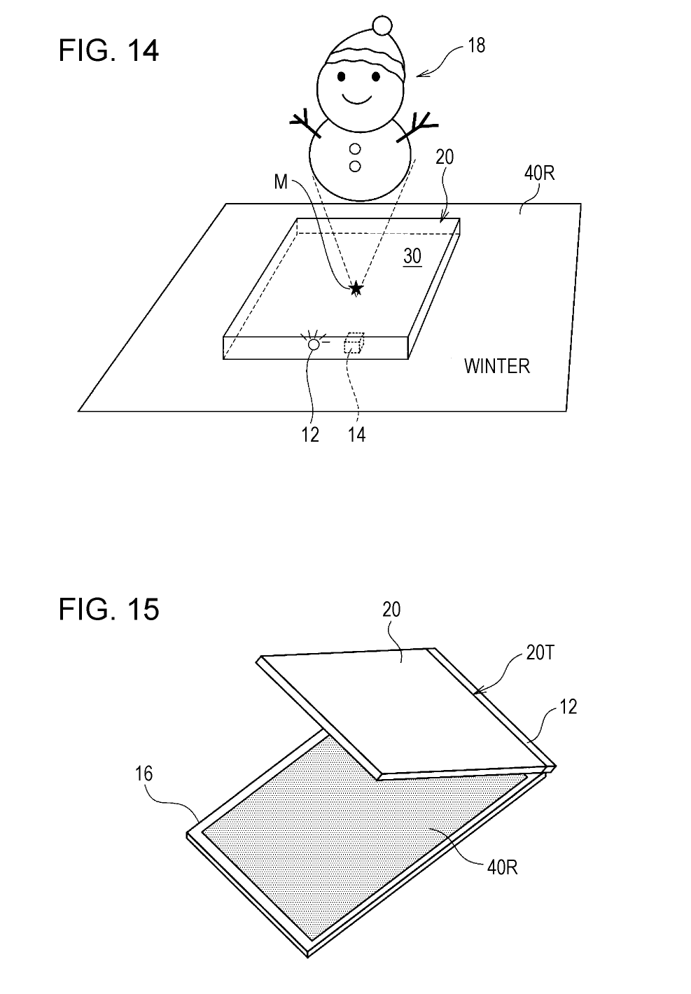

FIG. 14 is a perspective view of an example of a configuration of a sheet-shaped illumination apparatus according to an application. The sheet-shaped illumination apparatus includes the light source 12 and the light guide plate 20. Although it is not illustrated, the cladding layer 30 and the plural light exit portions 62 are provided on the second surface 20B of the light guide plate 20 (see FIG. 1). Furthermore, a battery 14 that supplies power to the light source 12 is mounted in the illumination apparatus.

The battery 14-mounted illumination apparatus is used even at places where it is difficult to provide a power source for the illumination apparatus. With the battery 14-mounted illumination apparatus, the user carries the illumination apparatus and reproduce a hologram at a variety of places. Furthermore, with the battery 14-mounted illumination apparatus, routing of a power cord is not necessary. Thus, the illumination apparatus is also used as a wall-mounted illumination apparatus.

The hologram recording medium 40R is a sheet-shaped recording medium in which a reflection hologram of a stereoscopic image is recorded. A recording position of the hologram is marked “M” in the hologram recording medium 40R. When the illumination apparatus is brought into tight contact with the M-marked position of the hologram recording medium 40R, the illumination beam exiting the light guide plate 20 through the first surface 20A (see FIG. 1) is radiated toward the hologram recording medium 40R. This causes a stereoscopic image 18 recorded in the hologram recording medium 40R to be displayed for the observer 100.

The hologram recording medium 40R may be a single recording medium or recording media bound into the form of a book or booklet (a book, a catalog, or the like). The above-described sheet-shaped illumination apparatus is suited for use as an illumination apparatus that illuminates holograms recorded in bound recording media.

### Display

Next, an application to a display is described.

FIG. 15 is a perspective view of an example of a configuration of a portable display according to an application. The portable display includes the light source 12, the light guide plate 20, and the hologram recording medium 40R. Although it is not illustrated, the cladding layer 30 and the plural light exit portions 62 are provided on the second surface 2013 of the light guide plate 20 (see FIG. 1). A reflection hologram is recorded in the hologram recording medium 40R.

The portable display also includes a holding member 16. The holding member 16 holds the hologram recording medium 40R from the back side. The holding member 16 secures the position of the hologram recording medium 40R so as to suppress positional deviation of the recording medium. The holding member 16 is formed of resin or metal that absorbs the illumination beam. The holding member 16 may hold the hologram recording medium 40R from the back side such that the holding member 16 is removable. This may facilitate changing of the hologram recording medium 40R.

One end portion of the holding member 16 and one end portion of the light guide plate 20 are connected by a hinge portion such that the holding member 16 and the light guide plate 20 are pivotable relative to each other about the hinge portion so as to open and close the portable display. The end surface 20T of the light guide plate 20 faces the hinge portion, and the light source 12 is disposed along hinge portion. The portable display may be compactly folded by superposing the light guide plate 20 on the holding member 16, and accordingly, convenient for carrying, The hologram recording medium 40R is moved together with the light guide plate 20 serving as the surface illumination apparatus to freely change an observation direction for observation of the stereoscopic image.

When the portable display is closed by pivoting the holding member 16 and the light guide plate 20, the first surface 20A of the light guide plate 20 and the hologram recording medium 40R are in tight contact with each other. The illumination beam exiting the light guide plate 20 through the first surface 20A (see FIG. 1) is radiated toward the hologram recording medium 40R. The reproduction beam exiting the hologram recording medium 40R passes through and exits the light guide plate 20. This causes the stereoscopic image recorded in the hologram recording medium 40R to be displayed for the observer 100.

### Other Applications

The display that includes the light source 12, the light guide plate 20, the hologram recording medium 40R, and the holding member 16 similarly to the application illustrated in FIG. 14 may have a “slit” between the light guide plate 20 and the hold ng member 16. The hologram recording medium 40R is inserted into and removed the slit.

Furthermore, a trim may be provided at the periphery of the above-described display, so that the display is used as a photo stand with illumination. The hologram recording medium 40R may have a “roll film” shape. In this case, the hologram recording medium 40R is changed by taking up the film.

The configurations of the illumination apparatus, the display, and the light guide device having been described are examples. Of course, the configurations may be changed without departing from the gist of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An illumination apparatus comprising:
a light source;
a light guide plate that includes
a first surface,
a second surface which faces the first surface, and
a plurality of light exit portions provided on one surface cut of the first surface and the second surface,
that guides through the light guide plate a beam of light incident upon one of the first surface and the second surface while reflecting the beam between the first surface and the second surface, and that redirects the beam incident upon any one of the plurality of light exit portions so as to cause the beam to exit the light guide plate; and
an adjacent layer that is provided adjacent to at least one surface out of the first surface of the light guide plate and the second surface of the light guide plate, that has a lower refractive index than a refractive index of the light guide plate, and that increases a critical angle compared to a critical angle observed when air exists instead of the adjacent layer.

2. The illumination apparatus according to claim 1,
wherein the adjacent layer decreases a range of an incident angle of the beam incident upon one of the first surface and the second surface.

3. The illumination apparatus according to claim 1,
wherein a difference in refractive index between the light guide plate and the adjacent layer is from 0.001 to 0.1.

4. The illumination apparatus according to claim 1,
wherein each of the plurality of light exit portions refracts the beam incident upon the light exit portion so as to cause the beam to exit through the one surface.

5. The illumination apparatus according to claim 1,
wherein each of the plurality of light exit portions reflects the beam incident upon the light exit portion so as to cause the beam to exit through another surface different from the one surface.

6. The illumination apparatus according to claim 1,
wherein each of the plurality of light exit portions causes the beam incident upon the light exit portion to exit at a predetermined angle.

7. A display comprising:
the illumination apparatus according to claim 1; and
a hologram recording medium to be illuminated with the beam exiting the illumination apparatus.

8. A light guide device comprising:
a light guide plate that includes
a first surface,
a second surface which faces the first surface, and
a plurality of light exit portions provided on one surface out of the first surface and the second surface,
that guides through the light guide plate a beam of light incident upon one of the first surface and the second surface while reflecting the beam between the first surface and the second surface, and that redirects the beam incident upon any one of the plurality of light exit portions so as to cause the beam to exit the light guide plate; and
an adjacent layer that is provided adjacent to at least one surface out of the first surface of the light guide plate and the second surface of the light guide plate, that has a lower refractive index than a refractive index of the light guide plate, and that increases a critical angle compared to a critical angle observed when air exists instead of the adjacent layer.
